(19) United States
(12) Patent Application Publication
(10) Pub. No.: US 2011/0171846 A1
(43) Pub. Date: Jul. 14, 2011

(54) Circuit Card Latching Arm Arresting Apparatus

(75) Inventors: John Albert Bauer, JR., Austin, TX (US); Christopher M. Jaggers, Austin, TX (US); John Trevor Morrison, Round Rock, TX (US)

(73) Assignee: Dell Products L.P., Round Rock, TX (US)

(21) Appl. No.: 12/685,214

(22) Filed: Jan. 11, 2010

(51) Int. Cl. H01R 13/62

(52) U.S. Cl. 439/326

(57) ABSTRACT

A circuit card is retained in a socket by a pair of movable arms engaging opposite sides of the card and securing the card in the socket. An arresting member is engaged with a portion of the card and engaged with the opposite sides and each of the movable arms, whereby the movable arms are maintained in engagement with the opposite sides of the card.

### BACKGROUND

The present disclosure relates generally to information handling systems, and more particularly to an arresting apparatus for securing latching arms in engagement with a circuit card.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Circuit cards such as dual inline memory module (DIMM) cards are mounted in sockets provided on circuit boards in IHSs such as laptop or notebook computers. The card is inserted into the socket at an angle with respect to the horizontally disposed circuit boards. When fully seated in the socket, the card is pivoted to a horizontal position on the board and a pair of resilient latching arms are urged outwardly and then resiliently move inwardly toward opposite edges of the circuit card into engagement with those opposite edges of the card. The resilient latching arms are provided to maintain the circuit card secured in its respective socket.

It has been found that in response to a shock event, the latching arms may release from their engagement with the edges of the circuit cards. In response, the circuit card may be released from the socket. Thus, operation of the IHS is interrupted.

Accordingly, it would be desirable to provide an improved circuit card latching arm arresting apparatus absent the disadvantages discussed above.

### SUMMARY

According to one embodiment, a circuit card is retained in a socket by a pair of movable arms engaging opposite sides of the card and securing the card in the socket. An arresting member is engaged with a portion of the card and engaged with the opposite sides and each of the movable arms, whereby the movable arms are maintained in engagement with the opposite sides of the card.

### BRIEF DESCRIPTION OF THE DRAWINGS

FIG. 1 is a diagrammatic view illustrating an embodiment of an IHS.

FIGS. 2, 3 and 4 are perspective views illustrating an embodiment of a DIMM card being inserted into a socket provided in an IHS chassis.

FIG. 5 is a perspective view illustrating an embodiment of an arresting member.

FIG. 6 is an inverted perspective view illustrating an embodiment of the arresting member of FIG. 5.

FIG. 7 is a perspective view illustrating an embodiment of the arresting member being mounted on the DIMM card of FIGS. 2, 3 and 4.

FIG. 8 is a perspective view illustrating an embodiment of the arresting member mounted on the DIMM card and maintaining the movable arms in engagement with opposite sides of the DIMM card.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

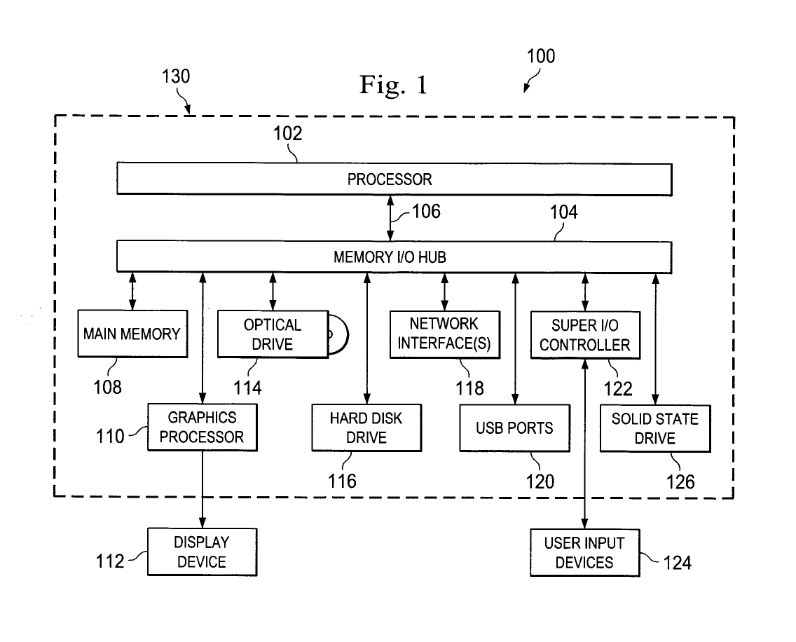

FIG. 1 is a block diagram of an IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116 and 126 may be located locally with the IHS 100, located remotely from the IHS 100, and/or they may be virtual with respect to the IHS 100. Portions of the system 100 are provided in an IHS chassis 130, FIG. 1. Other parts of the IHS 100 such as display 112 and input devices 124, such as a mouse and a keyboard for example are peripherally attached to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

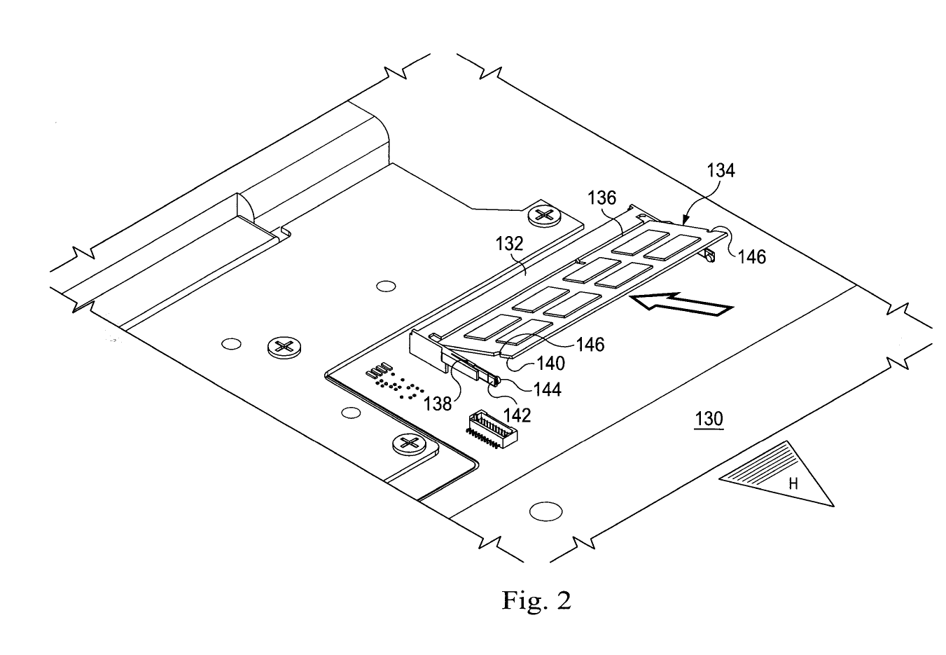

A portion of chassis 130 is illustrated in FIG. 2. In this embodiment, chassis 130 is a chassis of an IHS such as a laptop or notebook computer. Chassis 130 includes several components including a socket 132 for receiving a circuit card such as a DIMM card 134.

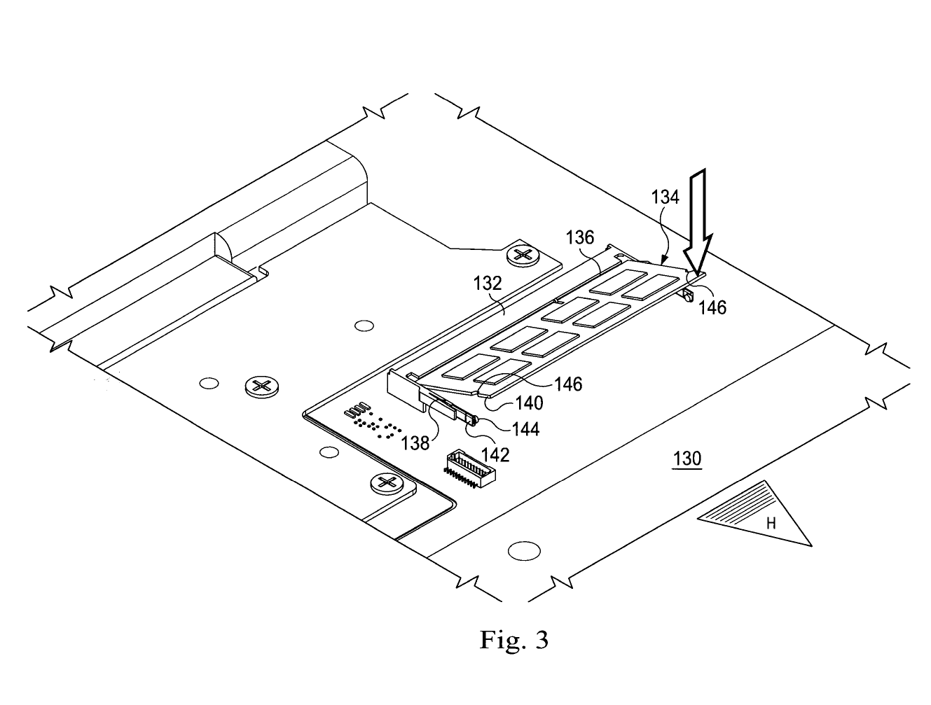

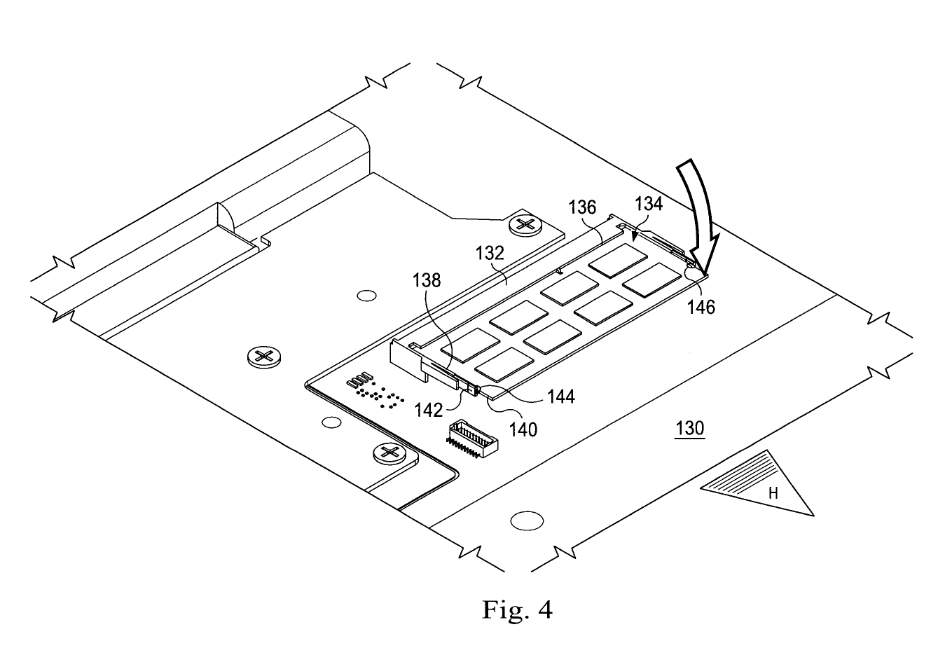

To insert card 134 into the socket 132, card 134 is commonly inserted at an angle to a horizontal plane H defined by the chassis 130. A contact end 136 of card 134 engages socket 132 and is manually urged into the socket 132. In response to the contact end 136 seating in the socket 130, FIGS. 3 and 4, manual pressure further urges the card 134 into seated alignment with the above-defined plane of chassis 130.

A pair of movable arms 138, FIG. 4, engage opposite sides 140 of the card 134 thus securing card 134 in socket 132. Each movable arm 138 is resiliently and flexibly mounted in chassis 130 as a result of the cantilever extension of a terminal end 142 of each arm 138. As a result, each end 142 is capable of movement toward and away from the opposite sides 140. In addition, a protruding tab 144 extends toward the sides 140 from each end 142.

Insertion of the card 134 between the arms 138, urges the arms 138 outwardly and upon seating of card 134 in socket 132, the arms move to their at-rest position by moving inwardly toward sides 140.

A pair of notches 146 are formed in each side 140 for receiving the tabs 144 as the arms move to their at-rest position as described above, thus allowing the tabs to snap into the notches 146 and assist in retaining the card 134 seated in the socket 132 by resisting movement of the card 134 in a direction away from the socket 132.

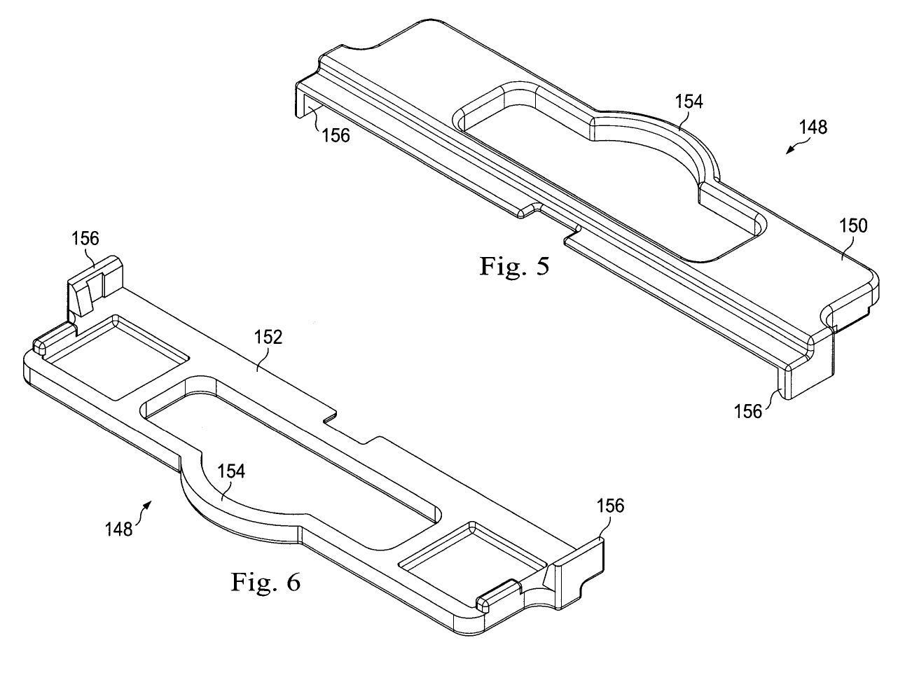

In FIGS. 5 and 6, an arresting member 148 is illustrated. Arresting member 148 is generally rectangular and includes a first or exterior surface 150, FIG. 5, and a second or interior surface 152, FIG. 6. A gripping portion 154 is of an arcuate shape for ease of manual handling. A pair of extended members or means 156, extend from interior surface 152, as will be discussed in further detail below.

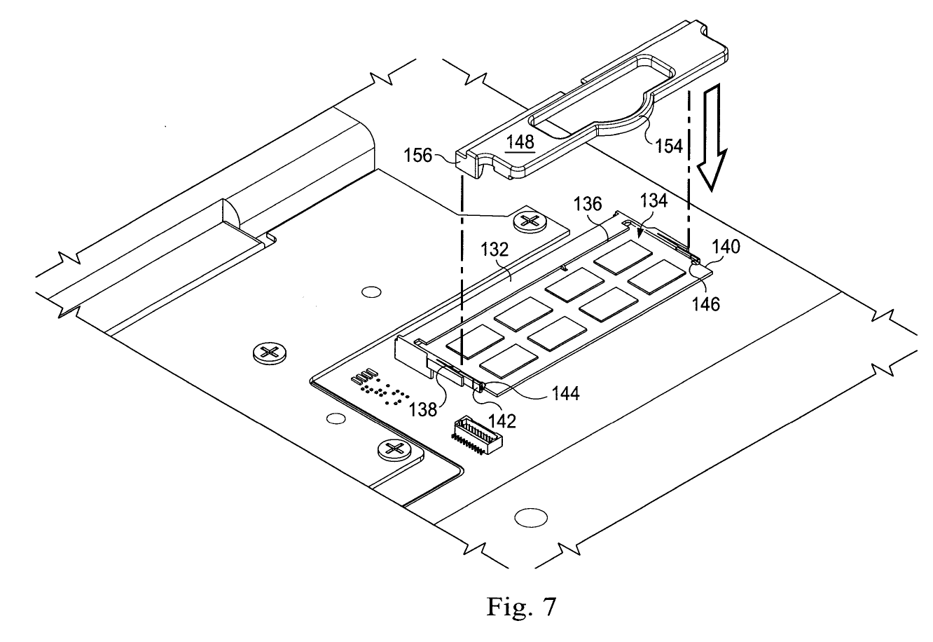

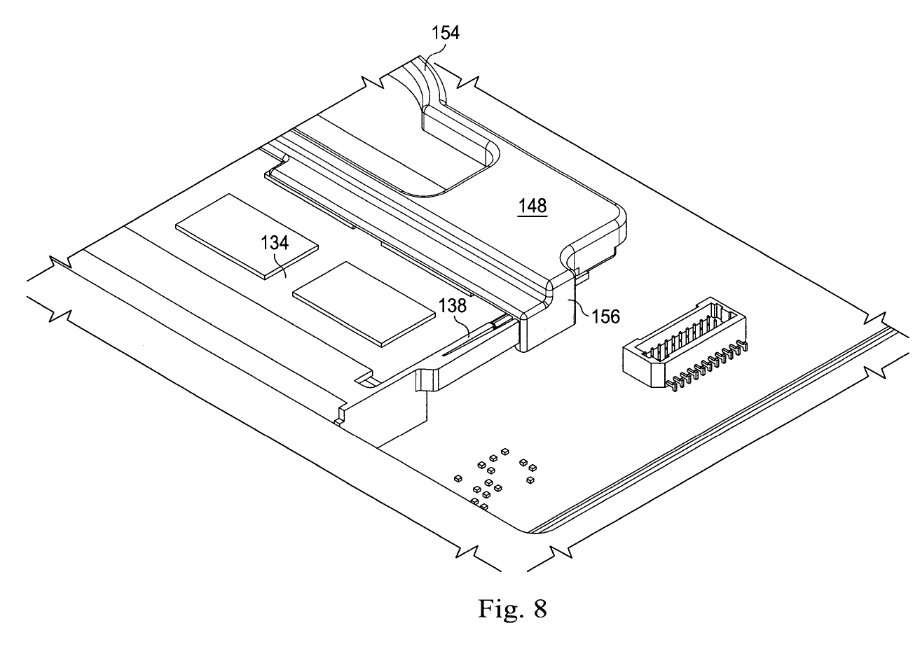

Following insertion of the card 134 and engagement of the arms 138 including tabs 144 in notches 146, as described above, arresting member 148 is engaged with a portion of the card 134, FIGS. 7 and 8. This is accomplished by manual gripping of gripping portion 154 of arresting member 148, FIG. 7, and installing the arresting member 148 on a portion of the card 134. The installation is accomplished in a manner which engages the interior surface 152 with a portion of card 134 and which positions extended members 156 in engagement with the movable arms 138 and maintains the tabs 144 engaged with the notches 146. As a result, a shock event such as the laptop IHS being dropped, is limited from dislodging the card 134 from the socket 132. This is because any momentary shock induced outward movement of the arms 138 is limited due to being engaged by the arresting members 148.

Further assembly of the laptop IHS includes a keyboard support (not shown) laid over the chassis 130, and a keyboard (not shown) laid over the keyboard support as is well-known.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An apparatus comprising:
a circuit card;
a pair of movable arms engaging opposite sides of the circuit card and securing the circuit card in an associated socket; and
an arresting member engaged with a portion of the circuit card and engaged with each of the movable arms, whereby the movable arms are maintained in engagement with the opposite sides of the circuit card.

2. The apparatus of claim 1 wherein the circuit card includes a notch formed in each of the opposite sides.

3. The apparatus of claim 2 wherein the movable arms each include a protruding tab.

4. The apparatus of claim 3 wherein each of the movable arms are resilient.

5. The apparatus of claim 4 wherein the circuit card is urged between the movable arms to position each protruding tab into engagement with an adjacent notch.

6. The apparatus of claim 1 wherein the arresting member includes a gripping portion.

7. The apparatus of claim 1 wherein the arresting member includes extended means for limiting movement of the movable arms.

8. An information handling system (IHS) comprising:
a chassis;
a circuit board mounted in the chassis;
a socket provided on the circuit board;
a circuit card mounted in the socket;
a pair of movable arms engaging opposite sides of the circuit card and securing the circuit card in the socket; and
an arresting member engaged with a portion of the circuit card and engaged with each of the movable arms, whereby the movable arms are maintained in engagement with the opposite sides of the circuit card.

9. The system of claim 8 wherein the circuit card includes a notch formed in each of the opposite sides.

10. The system of claim 9 wherein the movable arms each include a protruding tab.

11. The system of claim 10 wherein each of the movable arms are resilient.

12. The system of claim 11 wherein the circuit card is urged between the movable arms to position each protruding tab into engagement with an adjacent notch.

13. The system of claim 8 wherein the arresting member includes a gripping portion.

14. The system of claim 8 wherein the arresting member includes extended means for limiting movement of movable arms.

15. A method of retaining a circuit card in an information handling system comprising:
providing a socket on a circuit board;
mounting a circuit card in the socket;
moving a pair of arms into engagement with opposite sides of the circuit card and securing the circuit card in the socket; and
engaging an arresting member with a portion of the circuit card and with each of the moveable arms, whereby the movable arms are maintained in engagement with the opposite sides of the circuit card.

16. The method of claim 15 further comprising:
forming a notch in each of the opposite sides.

17. The method of claim 16 further comprising:
providing a protruding tab on each of the movable arms.

18. The method of claim 17 wherein each of the movable arms is a cantilever member having a flexible terminal end.

19. The method of claim 18 further comprising:
urging the circuit card between the movable arms and snapping the tabs into engagement with an adjacent notch.

20. The method of claim 15 further comprising:
providing extended means on the arresting member for limiting movement of the movable arms.
